(19) United States
(12) Patent Application Publication
(10) Pub. No.: US 2026/0299895 A1
(43) Pub. Date: Oct. 1, 2026

(54) MULTI-DEVELOPER CLOUD-BASED GAME DEVELOPMENT ENVIRONMENT WITH SHARED AND CLONED WORKSPACES

(71) Applicant: Sony Interactive Entertainment Inc., Tokyo (JP)

(72) Inventors: Kelvin Yong, Irvine, CA (US); Harshil Shah, Yorba Linda, CA (US)

(73) Assignee: Sony Interactive Entertainment Inc., Tokyo (JP)

(21) Appl. No.: 19/097,369

(22) Filed: Apr. 1, 2025

(51) Int. Cl. G06F 8/34

(52) U.S. Cl. CPC G06F 8/34

(57) ABSTRACT

Systems, methods, and code for allowing several game developers to efficiently collaborate in video game development. In one example, a data center can include a number of virtual development kits, each with access to the game code and assets for a video game. Each of a number of client devices can access and edit the game code and assets using one of the virtual development kits. Developers using the client devices can see the game code and assets in the edited form as edits are made by the various client devices. In another example, blocks of code being edited can be sequestered in a cloned workspace. This separation can help to prevent the debugging process on the blocks of code from slowing other development.

### BACKGROUND

Video games are an incredibly immersive form of entertainment. Whether played alone or in groups over the internet, video games can be challenging and engaging. For some games, player immersion can be enhanced with the inclusion of life-like characters, highly detailed virtual worlds, and other amazing enhanced graphical effects. As a result, video games are extremely complex and are created by large numbers of people in active collaboration. Thus, what is needed are systems, methods, and code for allowing large numbers of people to collaborate on the design and editing of video games.

### SUMMARY

Embodiments of the present invention can provide systems, methods, and code for allowing multiple game developers to work collaboratively on the design and editing of video games. These and other embodiments of the present invention can provide a data center having a number of virtual development kits, each with access to the game code and assets for a video game. In a first example, the game code and assets can be copied from a source code and stored in a shared workspace. The virtual development kits can be accessed through an interface. The interface can be accessed by client devices directly, for example when a client device is located at the data center. The interface can be accessed by individual developers via their client devices remotely over a network, such as the internet. Each of the developers can access and edit the game code and assets using one of the virtual development kits. Each client device can access the game code and assets in the shared workspace in real time as edits are made by the developers using their various client devices. In this way the game code and assets do not need to be repetitively downloaded to the client devices. This can allow the game code and assets to be collaboratively developed in a time and bandwidth efficient manner.

In this first example, multiple users (developers) can access a shared workspace where any user (developer) can see any changes. But in some circumstances, it can be desirable to provide a copy of at least some of the game code and assets for a developer to work on separately. For example, it might be understood that multiple attempts might be needed to get a block of code to work properly. Making such edits in real time could break the game for all the other developers and slow their progress. Accordingly, in a second example, a portion of code, a number of lines, a number of files, a block of code, or more than one or a combination of these, referred to here simply as a block of code for brevity, can be cloned or copied to a cloned workspace, which can colloquially be referred to as a sandbox. Since the developer needs this cloned workspace before they can continue working, it can be desirable that the block of code be quickly checked out and copied to the cloned workspace at a second location. It can also be desirable that the block of code can quickly be checked back in to the shared workspace at a first location when the edits are complete. These can both be accomplished by limiting an amount of code that is copied to the cloned workspace. Other code in the shared workspace that is not being edited in the cloned workspace can be linked to by the by the cloned workspace. This new instance of the game code can thus include code being edited and links to the shared workspace. This new instance of the game code can be tagged with a version number or version identification. The use of a cloned workspace can allow a developer to check out a block of code and segregate it from other developers until editing is complete.

A developer can check out a block of code by explicitly requesting that the block of code be cloned or copied over to the cloned workspace. The block of code can also or instead be automatically checked out and copied to the cloned workspace when a developer begins to edit the block of code. The developer editing the block of code can access both the game code and assets in the shared workspace and the cloned or copied block of code in the cloned workspace. The game code and assets in the shared workspace can be accessed directly or by using links in the cloned workspace. When the developer runs the game code on a virtual development kit, the game code can be drawn from the block of code in the cloned workspace when possible and otherwise from the game code and assets in the shared workspace or other cloned workspace when necessary, directly or by using links. The remaining development kits might not have access to the block of code in the cloned workspace and the corresponding developers might not be able to see the block of code. After modifications, the block of code can be verified and checked back into the main game code and assets in the shared workspace. The updated game code and assets can be verified. If an error arises, the code from the block of code can revert to the previous version. If no error arises, the development can proceed with the updated code.

In these and other embodiments of the present invention, it can be desirable for more than one developer to have access to a cloned workspace. In this case, a first developer can check out or begin editing code and a corresponding block of code can be transferred to a shared workspace. The first developer can grant access to one or more second developers, or one or more second developers can request access. The first developer and the one or more second developers can then efficiently collaborate on changes to the block of code. The block of code can then be verified and inserted back into the game code as before.

These and other embodiments of the present invention can provide a highly flexible and configurable arrangement for storing game code and assets. In one example, a first developer can work on a first block of code by using a first development kit to place the first block of code in a first cloned workspace. The first cloned workspace can include links to other code that is needed from the shared workspace. This can quickly provide game code and assets that can be run on a first virtual development kit by the first developer.

In this example, a second developer might want to work on a second block of code in a second cloned workspace. If the second block of code is available in the shared workspace, a second developer kit can generate a second cloned workspace to link to or clone the second block of code. If the second block of code is not available in the shared workspace, the second development kit can access the second block of code from another cloned workspace or other source. The second cloned workspace can include links to other code that is needed from the shared workspace or other cloned workspace. This can quickly provide game code and assets that can be run on a second virtual development kit by the second developer.

Further in this example, a third developer might want to access the first block of code from the first cloned workspace and the second block of code from the second cloned workspace. A third development kit can link to or copy the first block of code from the first cloned workspace and the second block of code from the second cloned workspace to generate the third cloned workspace. The third cloned workspace can include links to other code that is needed from the shared workspace or other cloned workspace. This can quickly provide game code and assets that can be run on the third virtual development kit by the third developer.

In this example, a conflict can arise since both the first and third developers are working on the first block of code. Accordingly, each copy of the first block of code can be assigned a version number or version identification. Other developers accessing the first block of code can then specify which version of the first block they want to link to or clone.

Blocks of code in a cloned workspace can be locked in order to inform other developers that editing is being performed and to prevent the code being edited from being accessed. In the above example, the first developer can put a lock on lines of code in the first block of code, the first developer can put a lock on files in the first block of code, the first developer can put a lock on the first block of code, or the first developer can put a lock on another amount of code that the first developer is editing or otherwise wished to lock. Other developers who are accessing the first block of code can be directed to a previous version of the first block of code. The lock can also inform the other developers that the first block or code, or a portion thereof, is being edited. The lock can include other related information, such as the identity of the developer that placed the lock, the identity of the group that developer that placed the lock belongs to, when the lock is expected to be removed, and other information.

In some circumstances, it might be desirable to limit access by a developer to a specific block of code or type of code without granting access to the entire game code and assets in the shared workspace. For example, an artist might need to access a block of code for artwork without needing to access the entire game. An engineer might need to access only the physics engine. Limiting access to specific blocks of code can reduce the chance of accidental editing and enhance security. In this circumstance, a first developer can clone or generate links to a block of code for storage in a cloned workspace. The first developer can grant permission to the second developer such that the second developer can access the block of code in the cloned workspace but cannot access the main game code and assets in the shared workspace.

In these and other embodiments of the present invention, groups of one or more developers might want to clone or link to blocks of code. In this case, a first group of one or more developers can check out a first block of code by requesting that the first block of code be cloned to a first cloned workspace or by editing lines of code in the first block of code in the shared workspace. A second group of one or more developers can check out a second block of code by requesting that the second block of code be cloned to a second cloned workspace or by editing lines of code in the first block of code in the shared workspace. Each group of developers can collaboratively edit code in their corresponding block of code. The blocks of code can be verified. A check can be run to see if the first block of code and the second block of code are in conflict. A conflict can arise from having overlapping or interdependent lines of code, or for other reason. Where there is not conflict, each block of code can be checked in and the updated game code can be verified. Where a conflict does arise, the conflict can be arbitrated and some or all of the first block of code and the second block of code can be used to update the game code in the shared workspace. The arbitration can be based on a first-come-first-served basis, or other algorithm can be used.

In these and other embodiments of the present invention, small amounts of code can be cloned or copied from the shared workspace to a cloned workspace. This can speed the creation of a cloned workspace for use by a developer. When a small amount of code is needed by a cloned workspace but is not being edited, the code can be cloned and stored in the cloned workspace. Alternatively, code can be linked to by links in the cloned workspace. Where the small amount of code is to be edited, or is being edited, it can be cloned or copied.

This ability to check out smaller blocks of code and provide links to other needed code from a shared workspace can greatly increase the efficiency of the development of game code and assets. For example, the game code does not need to be rebuilt every time that lines of code are changed. The ability to edit and then have those edits available without having to rebuild can greatly decrease the time needed to make an update. Where a rebuild is needed, only edited code might need to be rebuilt, greatly speeding the process.

Again, in some circumstances it can be desirable to transfer an amount of game code and assets from the shared workspace to a cloned workspace. This can allow a developer to work on the transferred code without concern for breaking the game code and assets that are being accessed by other developers. It can be desirable to reduce the amount of data transferred among these different memories to speed development, reduce internal bandwidth usage, and reduce power consumption. Accordingly, data can be transferred from the game code and assets to a cloned workspace for use by one or more developers in different ways.

For example, the amount of code transferred can be limited by only cloning or copying lines of game code that are actually edited by the developer. This transferring can be simplified by copying or cloning only specific files that are actually edited by the developer. This transferring can be simplified by copying or cloning only blocks of code that are actually edited by the developer. The transferring can be implemented by copying or cloning files that are requested by the developer. The transferring can be implemented by copying or cloning blocks of code that are requested by the developer.

Edited code can be copied from the shared workspace back to the shared workspace storing the game code and assets in different ways. For example, only the lines of code that have actually been edited in the cloned workspace might be written back to the shared workspace. Only the files that have actually been edited in the cloned workspace might be written back to the shared workspace. Only the blocks of code that have actually been edited in the cloned workspace might be written back to the shared workspace. Only the lines of code that the developer requests to be written back might be written back to the shared workspace. Only the files that the developer requests to be written back might be written back to the shared workspace. Only the blocks of code that the developer requests to be written back might be written back to the shared workspace.

In these and other embodiments of the present invention, various techniques can be used to determine what lines of code have been edited by a client device. These techniques can include running the game program with both the game code in the first location and the block of code in the second location for a few commands, then running and comparing checksums between the two.

In these and other embodiments of the present invention, development kits can include code for measuring performance parameters of the game code and assets. For example, they can include code for debugging, estimating frame rate, power dissipation, load times, and other parameters.

In these and other embodiments of the present invention, various data center components can be responsible for creating cloned workspaces, for cloning code, for linking to code, and other functions. Each of these tasks can be performed by the various data center components alone or in combination. These data center components can include development kits, an interface, a data manager (not shown), or other data center component.

### BRIEF DESCRIPTION OF THE DRAWINGS

FIG. 1 illustrates a system for collaborating on the design and editing of a video game according to an embodiment of the present invention;

FIG. 2 illustrates a method of operating a collaboration system for the design and editing of a video game according to an embodiment of the present invention;

FIG. 3 illustrates another system for collaborating on the design and editing of a video game according to an embodiment of the present invention;

FIG. 4 illustrates another method of operating a collaboration system for the design and editing of a video game according to an embodiment of the present invention;

FIG. 5 illustrates another method of operating a collaboration system for the design and editing of a video game according to an embodiment of the present invention;

FIG. 6 illustrates another system for collaborating on the design and editing of a video game according to an embodiment of the present invention;

FIG. 7 illustrates another system for collaborating on the design and editing of a video game according to an embodiment of the present invention;

FIG. 8 illustrates another method of operating a collaboration system for the design and editing of a video game according to an embodiment of the present invention;

FIG. 9 illustrates another system for collaborating on the design and editing of a video game according to an embodiment of the present invention;

FIG. 10 illustrates another method of operating a collaboration system for the design and editing of a video game according to an embodiment of the present invention; and

FIG. 11 illustrates a simplified block diagram of a hardware system suitable for implementing a computer system according to an embodiment of the present invention.

### DESCRIPTION OF ILLUSTRATIVE EMBODIMENTS

Storing game code and assets in a data center can provide several advantages. For example, the game code and assets can be terabytes or more of data. This can be difficult for a developer to store and efficiently access on a client device. As such, it might not be feasible for a client device to store different versions of blocks of code for the game. Using the storage capability of a data center can allow multiple versions of game code, blocks of game code, assets, and other game data to be stored and quickly shared. This can allow a previous version of a block of game code to be reinstated quickly once a determination that an updated version is causing an error. An example of such as data center is shown in the following figure.

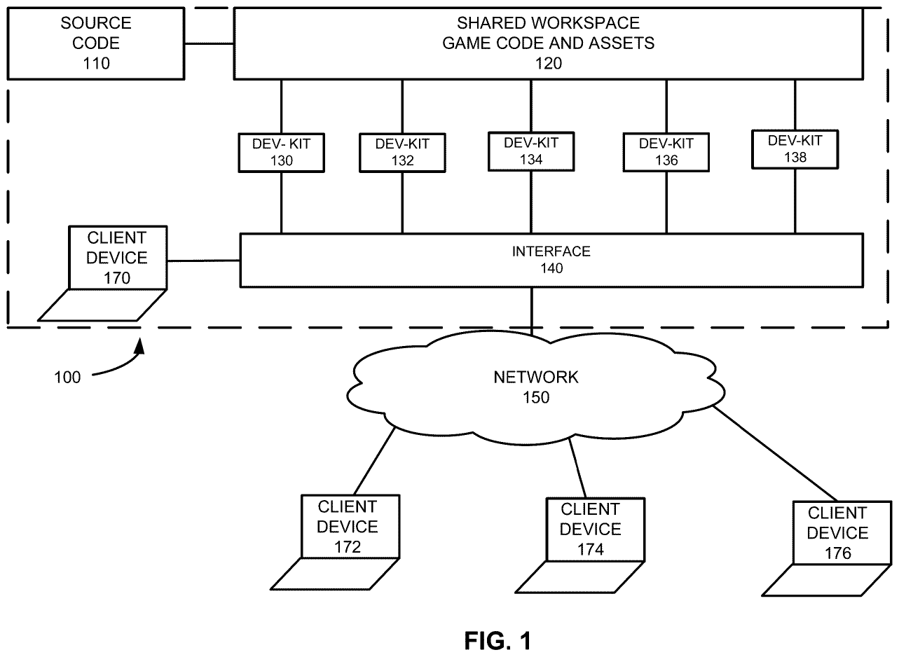

FIG. 1 illustrates a system for collaborating on the design and editing of a video game in a data center according to an embodiment of the present invention. In this example, data center 100 can include source code 110 and shared workspace 120. Source code 110 can include game code and assets for a game program that is being developed. Source code 110 can be downloaded to shared workspace 120. Backup versions of source code 110 and shared workspace 120 can be provided in data center 100 and are omitted for clarity. Source code 110 is also omitted from the other data center examples herein for clarity.

Data center 100 can further include virtual development kits 130 through 138, collectively referred to as development kits 130. Each development kit 130 can be configured as an emulator of a consumer or other console, a computer system, a handheld gaming device, or other electronic device. Each development kit 130 can include tools for working with application program interfaces. Each development kit 130 can include diagnostic programs for assisting in debugging, performance estimation, and other purposes. In these and other embodiments of the present invention, development kits can include code for measuring performance parameters of the game code and assets. For example, they can include code for debugging, estimating frame rate, power dissipation, load times, and other parameters.

The development kits 130 can be accessed through interface 140. Interface 140 can connect one or more client devices 170 through 176, collectively referred to as client devices 170, to development kits 130. Client devices 170 can be laptop computers, desktop computers, portable computing devices, consumer consoles, phones, handheld computing devices, or any device capable of performing the tasks of a client device in the methods described. Where some developments kits 130 are different, interface 140 can route client devices 170 to appropriate development kits 130 as needed. Interface 140 can route client devices 170 that are present at data center 100 directly to development kits 130. Interface 140 can route client devices 170 that are connected through network 150 to development kits 130.

In this example, the game code and assets can be copied from source code 110 and stored in shared workspace 120. Development kits 130 can be accessed through interface 140. Interface 140 can be accessed by developers through their client devices 160 directly, for example when client device 170 is located at data center 100. Interface 140 can be accessed by individual developers via their client devices 170 remotely over network 150. Network 150 can be the internet or other network. Each of developer can access and edit the game code and assets using one of the virtual development kits 130. Each developer can access the game code and assets in shared workspace 120 in real time as edits are made by developers using their various client devices 170. In this way, the game code and assets do not need to be repetitively downloaded to client devices 170. Not requiring repetitive downloads can allow the game code and assets to be collaboratively developed in a time and bandwidth efficient manner.

Again, in this example, multiple developers can access shared workspace 120 such that any developer can see any changes. This can greatly enhance collaboration. In order to avoid errors introduced by one virtual machine from corrupting the shared workspace for an extended duration, code updates can be tagged with version numbers or other version identification. When a code update causes errors, or “breaks the game,” the shared workspace can revert to a previous version. An example is shown in the following figure.

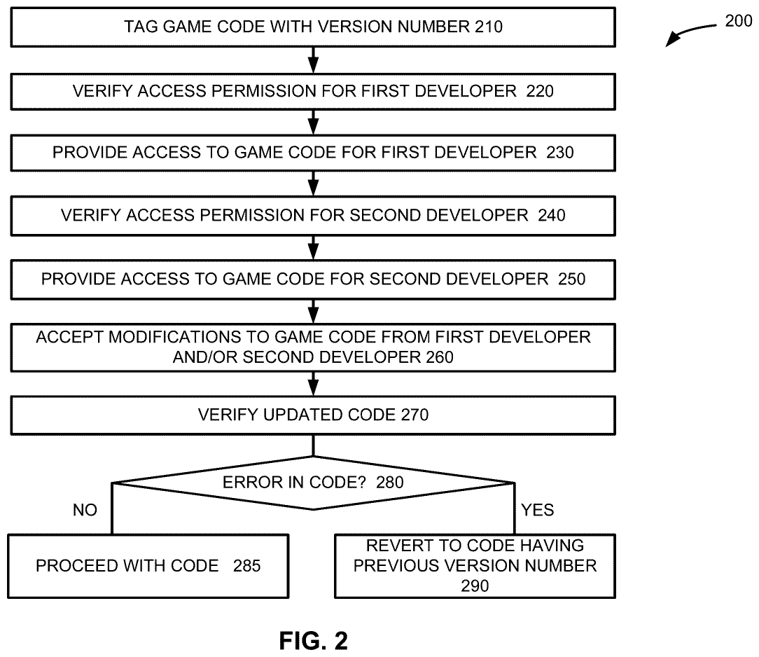

FIG. 2 illustrates a method of operating a collaboration system for the design and editing of a video game according to an embodiment of the present invention. In act 210 of method 200, the game code and assets can be given a version number. In act 220, permission can be verified for a first developer and access to the game code can be granted in act 230. In act 240, permission can be verified for a second developer and access to the game code can be granted in act 250. These permission and permission verification acts are omitted from the other methods shown herein but can be included.

Modifications can be accepted from either or both the first developer and the second developer in act 270. In act 280, it can be determined if an error has been introduced. If an error has not been introduced, the developers can proceed with the code in act 285. If an error has been introduced, the game code can revert to an earlier version in act 290.

Again, in this first example, multiple developers can access a shared workspace where any developer can see any changes. But in some circumstances, it can be desirable to provide a copy of at least some of the game code and assets for a developer to work on separately. For example, it might be understood that multiple attempts might be needed to get some code to work properly. Making such edits in real time in the shared workspace could break the game for all the other developers and slow their progress. Accordingly, in a second example, a portion, a number of lines, a number of files, a block of game code and assets, or a combination thereof, simply referred to here as a block of code for brevity, can be copied to a cloned workspace at a second storage location, which again can colloquially be referred to as a sandbox. Since this copy is needed before the developer can continue working, it can be desirable that the block of code be quickly checked out and copied to the cloned workspace. It can also be desirable that the block of code can be quickly checked back in to the shared workspace when the edits are complete. These can both be accomplished by limiting an amount of data that is copied to the cloned workspace. Other code in the shared workspace that is not being edited in the cloned workspace can be linked to by the by the cloned workspace. This new instance of the game code can thus include code being edited as well as links to code in the shared workspace. Other related code that is not being edited, for example code that provide context, can be cloned or linked to in the cloned workspace as well. This new instance of the game code can be tagged with a version number or version identification. The use of a cloned workspace can allow a developer to check out a block of code and segregate it from other developers until editing is complete. An example is shown in the following figure.

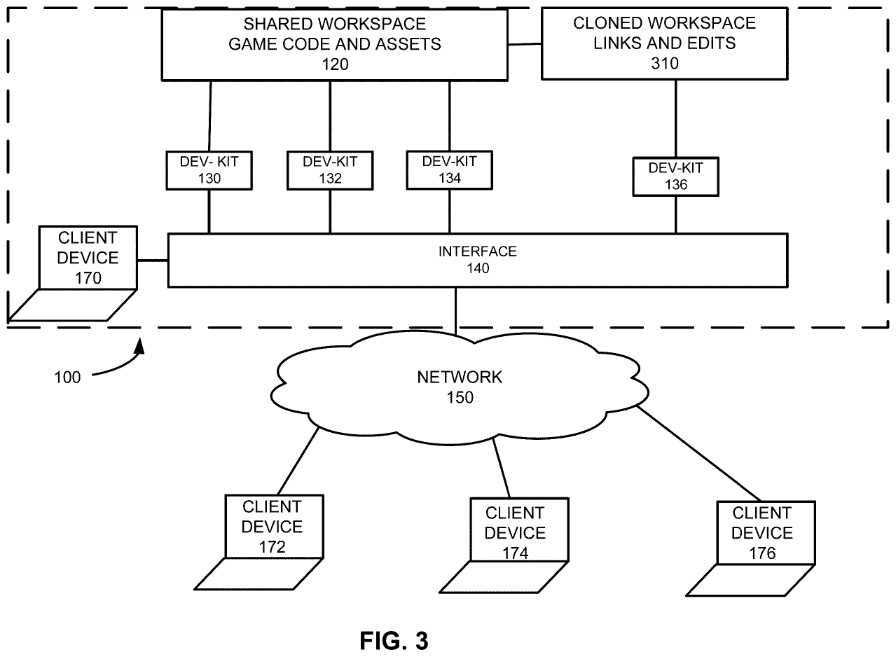

FIG. 3 illustrates another system for collaborating on the design and editing of a video game according to an embodiment of the present invention. In this example, development kits 130 through 134 can access game code and assets in shared workspace 120 as before. Development kit 136 can access cloned workspace 310. One of the client devices 170 can access development kit 136, and therefor cloned workspace 310, via interface 140 or via network 150 and interface 140.

Cloned workspace 310 can include code being edited by a developer using development kit 136 via a client device 170. Cloned workspace 310 can also include links to game code and assets in shared workspace 120 or other cloned workspaces that are needed by development kit 136 and is not being edited. This arrangement can reduce the memory size needed for cloned workspace 310, since only code being edited (and related code) and links are stored. It can also speed the creation time of cloned workspace 310 since large amounts of data do not need to be downloaded, copied over, or otherwise reproduced.

In these circumstances, it can be desirable to transfer an amount of game code and assets from shared workspace 120 to cloned workspace 310. This can allow a developer to work on the transferred code without concern for breaking the game code and assets that is being accessed by other developers. It can be desirable to reduce the amount of data transferred between the shared workspace 120 and the cloned workspace 310 to speed development, reduce internal bandwidth usage, and reduce power consumption. Accordingly, game code and assets can be transferred from shared workspace 120 to cloned workspace 310 for use by one or more developers in different ways.

For example, the amount of code transferred can be limited by only cloning or copying lines of game code that are actually edited using development kit 136. This transferring can be simplified by copying or cloning only specific files that are actually edited using development kit 136. This transferring can be simplified by copying or cloning only blocks of code that are actually edited using development kit 136. The transferring can be implemented by copying or cloning blocks or code that are requested to be cloned using development kit 136. The transferring can be implemented by copying or cloning blocks of code that are requested to be cloned using development kit 136.

Edited code can be copied from the cloned workspace 310 back to shared workspace 120 in different ways. For example, only the lines of code that have actually been edited in the cloned workspace 310 might be written back to shared workspace 120 by development kit 136. Only the files that have actually been edited in cloned workspace 310 might be written back to shared workspace 120 by development kit 136. Only the blocks of code that have actually been edited in cloned workspace 310 might be written back to shared workspace 120 by development kit 136. Only the lines of code that the developer requests to be written back might be written back to shared workspace 120 by development kit 136. Only the files that the developer requests to be written back might be written back to shared workspace 120 by development kit 136. Only the blocks of code that the developer requests to be written back might be written back to shared workspace 120 by development kit 136.

In these and other embodiments of the present invention, various data center components can be responsible for creating cloned workspaces, for cloning code, for linking to code, and other functions. Each of these tasks can be performed by the various data center components alone or in combination. These data center components can include development kits 130, interface 140, a data manager (not shown), or other data center component.

In these examples, a developer can check out a block of code by explicitly requesting via client device 170 and development kit 136 that the block of code be cloned or copied over to cloned workspace 310. The block of code can also or instead be automatically checked out and copied to the cloned workspace when a developer begins to edit the block using development kit 136. The developer editing the block of code can access both the main game code and assets in shared workspace 120 and the cloned or copied block of code in cloned workspace 310. The game code and assets in shared workspace 120 can be accessed directly or by using links in cloned workspace 310. Once cloned workspace 310 is configured, the code stored can be assigned a version number or version identification. When the developer runs the game code on virtual development kit 136, the game code can be drawn from the block of code in the cloned workspace when possible and otherwise from the game code and assets in shared workspace 120 or other cloned workspaces when necessary, directly or by using links.

The remaining development kits might not have access to the block of code in cloned workspace 310 and the corresponding developers might not be able to see the block of code. After modifications, the block of code can be verified and checked back into the main game code and assets in shared workspace 120. The updated game code and assets can be verified. If an error arises, the code from the block of code can revert to the previous version. If no error arises, the development can proceed with the updated code. Examples are shown in the following figures.

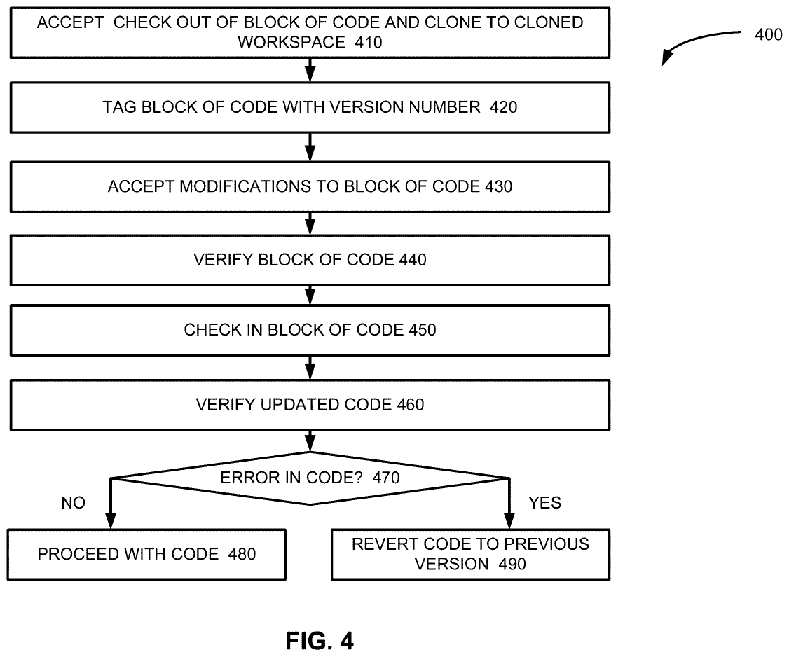

FIG. 4 illustrates another method of operating a collaboration system for the design and editing of a video game according to an embodiment of the present invention. In act 410 of method 400, a developer can check out a block of code from a shared workspace using a development kit 130 and place it in a cloned workspace. In act 420, the code can be tagged with a version number or version identification. The block of code can be modified by a developer over a client device in communication with a virtual development kit in act 430. The block of code can be tested and verified using the virtual development kit in act 440. In act 450, the edited block of code can be checked in to the shared workspace. The game code and assets in the shared workspace can be verified in act 460. If there is no error detected in act 470, development with the updated code can proceed in act 480. If there is an error detected in act 470, the game code and assets in the shared workspace can revert to an earlier version in act 490.

In this example, a block of code can be checked out by a developer by requesting the block of code be cloned to a cloned workspace. In these and other embodiments of the present invention, a cloned workspace can start when a developer begins to edit a block of code. An example is shown in the following figure.

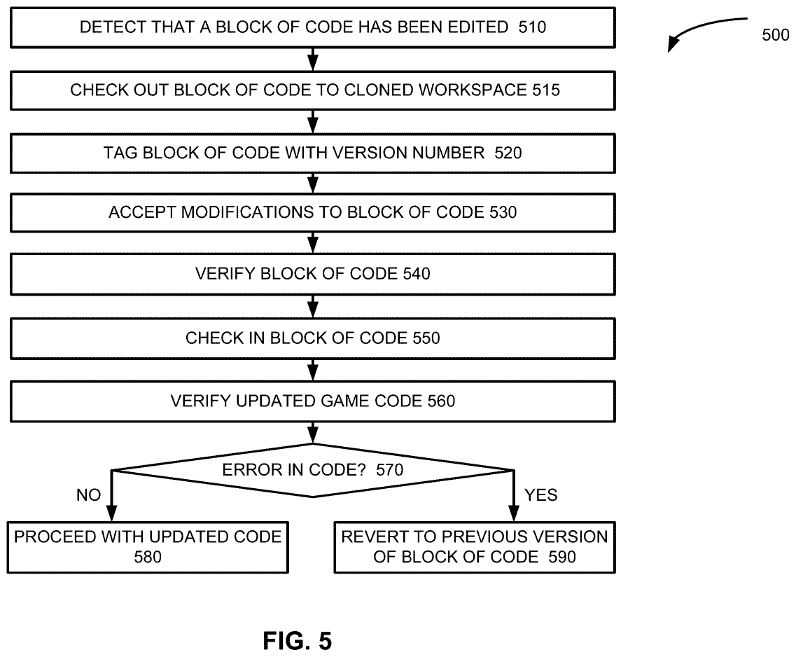

FIG. 5 illustrates another method of operating a collaboration system for the design and editing of a video game according to an embodiment of the present invention. In act 510 of method 500, a data center manager, developer kit, or other software or software and hardware combination, can detect that a block of code has been edited by a development kit. In response, the manager, development kit, or other or other software or software and hardware combination, can copy or clone the block of code to a cloned workspace in act 515. In act 520, the code can be tagged with a version number or version identification. The block of code can be modified by a developer over a client device in communication with a virtual development kit in act 530. The block of code can be tested and verified using the virtual development kit in act 540. In act 550, the edited block of code can be checked in to the shared workspace. The game code and assets in the shared workspace can be verified in act 560. If there is no error detected in act 570, development with the updated code can proceed in act 580. If there is an error detected in act 570, the game code and assets in the shared workspace can revert to an earlier version in act 590.

In these and other embodiments of the present invention, it can be desirable for more than one developer to have access to cloned workspace 310. In this case, a first developer can check out or begin editing code and a corresponding block of code can be transferred to a cloned workspace. The first developer can grant access to one or more second developers, or one or more second developers can request access. The first developer and the one or more second developers can then efficiently collaborate on changes to the block of code. The block of code can then be verified and inserted back into the game code as before. An example is shown in the following figure.

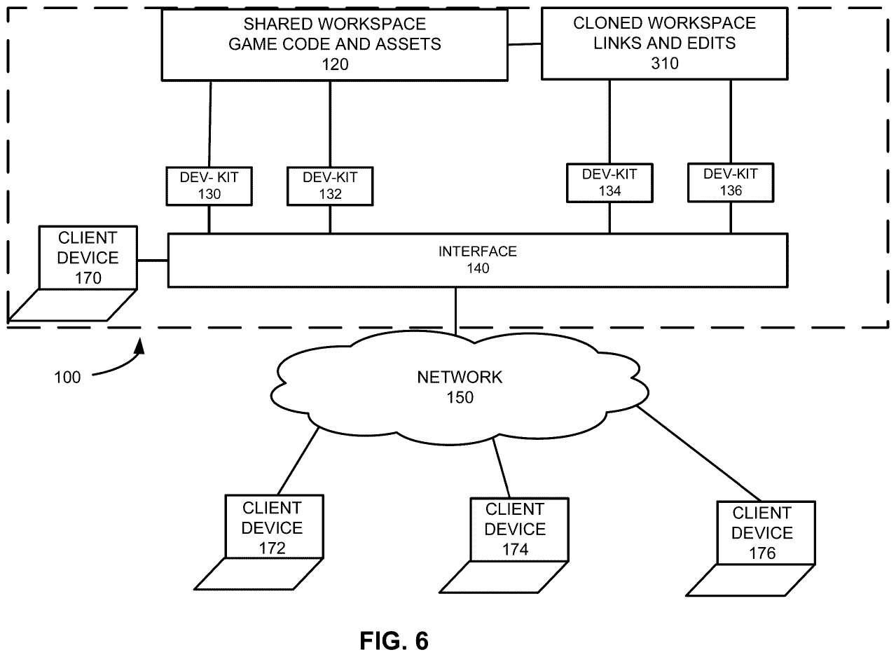

FIG. 6 illustrates another system for collaborating on the design and editing of a video game according to an embodiment of the present invention. In this example, a first developer can check out or begin editing code in shared workspace 120 such that cloned workspace 310 is created. The first developer can edit code in shared workspace 120 using development kit 134. Development kit 134 can be accessed by the first developer using a client device 170 directly or via network 150, where network 150 can be the internet. A block of code to be edited using development kit 136 can be copied to cloned workspace 310 from shared workspace 120. Links that point back to code that might also be needed in shared workspace 120 can be included in cloned workspace 310. In this way, cloned workspace 310 can be generated quickly and at a low bandwidth and time cost.

Also in this example, developers can use development kit 130 and development kit 132 to collaborate on edits to game code and assets in shared workspace 120. This collaboration can extend to cloned workspace 310 as well. For example, the first developer can grant access permission to a second developer using development kit 136, or a second developer using development kit 136 can request permission. Once permission is granted to the second developer, the first and second developer can use development kit 134 and development kit 136, via a client device 170, to collaborate on editing code in cloned workspace 310.

Blocks of code in cloned workspace 310 can be locked to inform other developers that editing is being performed and to prevent access by others. In this example, the first developer can put a lock on lines of code in the first block of code, the first developer can put a lock on files in the first block of code; or the first developer can put a lock on the first block of code in cloned workspace 310. Other developers, for example developers using development kit 130 or development kit 132, who are accessing the first block of code, can be directed to a previous version of the first block of code. The lock can also inform the other developers that the first block or code, or a portion thereof, is being edited. The lock can include other related information, such as the identity of the developer that placed the lock, the identity of the group that the developer that placed the lock belongs to, when the lock is expected to be removed, and other information.

In some circumstances, it might be desirable to limit access by a developer to a specific block of code or type of code without granting access to the entire game code and assets in shared workspace 120. For example, an artist might need to access a block of code for artwork without needing to access the entire game. An engineer might need to access only the physics engine. Limiting access to specific blocks of code can reduce the chance of accidental editing and enhance security. In this circumstance, a first developer can clone or generate links to a block of code for storage in a cloned workspace. The first developer can grant permission to the second developer such that the second developer can access the block of code in the cloned workspace but can't access the main game code and assets in the shared workspace. An example is shown in the following figure.

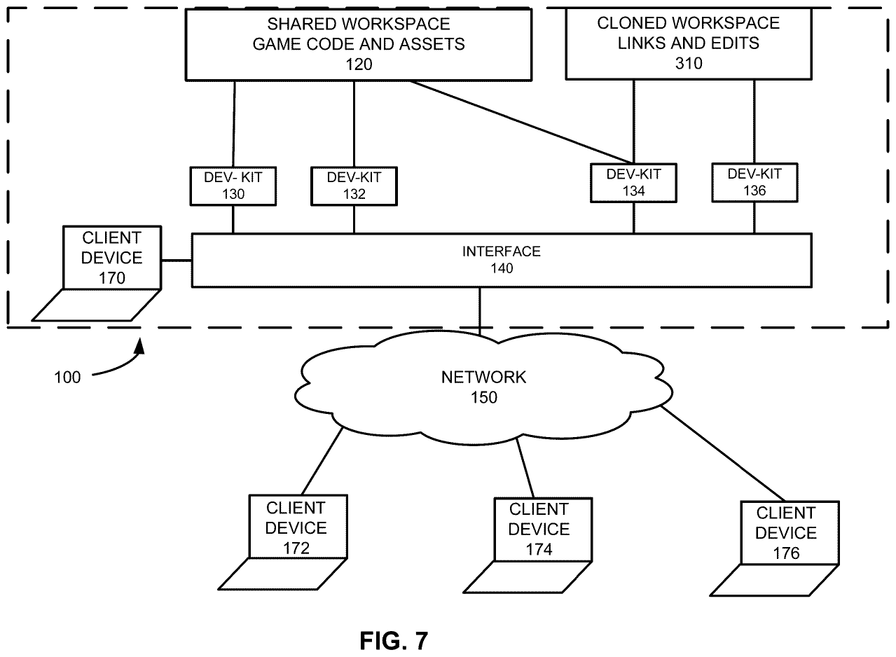

FIG. 7 illustrates another system for collaborating on the design and editing of a video game according to an embodiment of the present invention. In this example, a developer using development kit 134 can create cloned workspace 310 as before. Permission can be granted to a second developer using development kit 136 to access cloned workspace 310. The first developer using development kit 134 can access code in the cloned workspace 310. The first developer can access code in shared workspace 120, either directly or by using links, where the links are not available to development kit 136. The second developer using development kit 136 can access code in cloned workspace 310, but not code in shared workspace 120, either directly or by using links. Again, this limited access to specific blocks of code can reduce the chance of accidental editing and enhance security. An example is shown in the following figure.

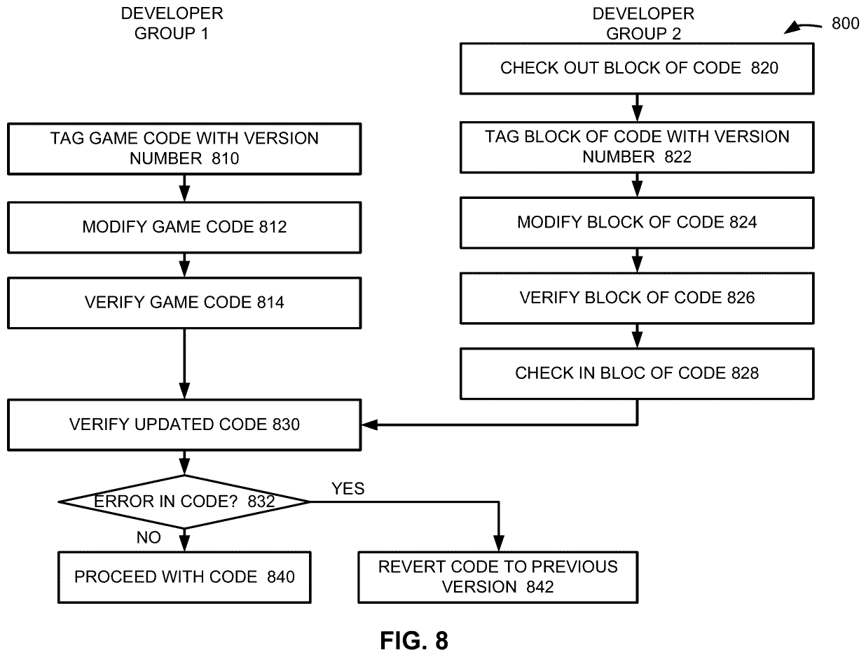

FIG. 8 illustrates another method of operating a collaboration system for the design and editing of a video game according to an embodiment of the present invention. In this example, two groups of developers can be working on a game code and assets. A first group, developer group 1, can be working in a shared workspace, such as shared workspace 120, while a second group, developer group 2, can be working in a cloned workspace, such as cloned workspace 310. Each of the first group of developers and the second group of developers can include one or more developers. In this example, the first developer group can begin working on game code and assets in a shared workspace. The game code and assets can be tagged with a version number or version identification in act 810 of method 800. In act 812, the first group of developers can modify the game code. In act 814, the game code can be verified.

In act 820, the second group of developers can check out or begin editing code in the shared workspace. As a result, lines of code, files, or a block of code can be moved to a cloned workspace where the second group of developers can edit the code. In act 822, the cloned code can be tagged with a version number or version identification. In act 824, the code can be modified, and the modifications can be verified in act 826.

In act 828, the second group of developers can check the block of code back in from the cloned workspace to the shared workspace. This update can be verified in act 830. In act 832, it can be determined whether an error was introduced by the combination of edits. If an error was not introduced, then both groups of developers can proceed with the new code in act 840. If an error was introduced, then the game code can be reverted to a previous version in act 842.

In this example, both the shared workspace code and the cloned workspace code can be verified independently in acts 814 and 826, and then the combination can be verified in act 830. If an error arises after the shared workspace code and the cloned workspace code have been verified, then the combination of the two sets of edits (edits to the shared workspace and edits to the cloned workspace) can be causing the error. This can be because the two sets of edited code are in conflict with each other by having overlapping lines. This can also be because the two sets of code having interdependent lines of code, or for other reasons. This can be resolved in different ways. For example, the code in both the shared workspace and the cloned workspace can revert to a previous version. Instead, the code in the cloned workspace can revert and the modifications to the shared workspace by the cloned workspace code can revert to a previous version. Instead, the code in the shared workspace can revert and the modifications to the cloned workspace can revert to a previous version.

In these and other embodiments of the present invention, two or more groups of one or more developers might want to clone or link to blocks of code. In this case, a first group of one or more developers can check out a first block of code by requesting that the first block of code be cloned or linked to a first cloned workspace or by editing lines of code in the first block of code in the shared workspace. A second group of one or more developers can check out a second block of code by requesting that the second block of code be cloned or linked to by a second cloned workspace or by editing lines of code in the first block of code in the shared workspace. Each group of developers can collaboratively edit code in their corresponding block of code. The blocks of code can be verified. A check can be run to see if the first block and second block of code are in conflict. A conflict can arise from having overlapping or interdependent lines of code, or for other reason. Where there is not conflict, each block of code can be checked in and the updated game code can be verified. Where a conflict does arise, the conflict can be arbitrated and some or all of the first block of code and the second block of code can be used to update the game code in the shared workspace. The arbitration can be based on a first-come-first-served basis, or other algorithm can be used. An example is shown in the following figure.

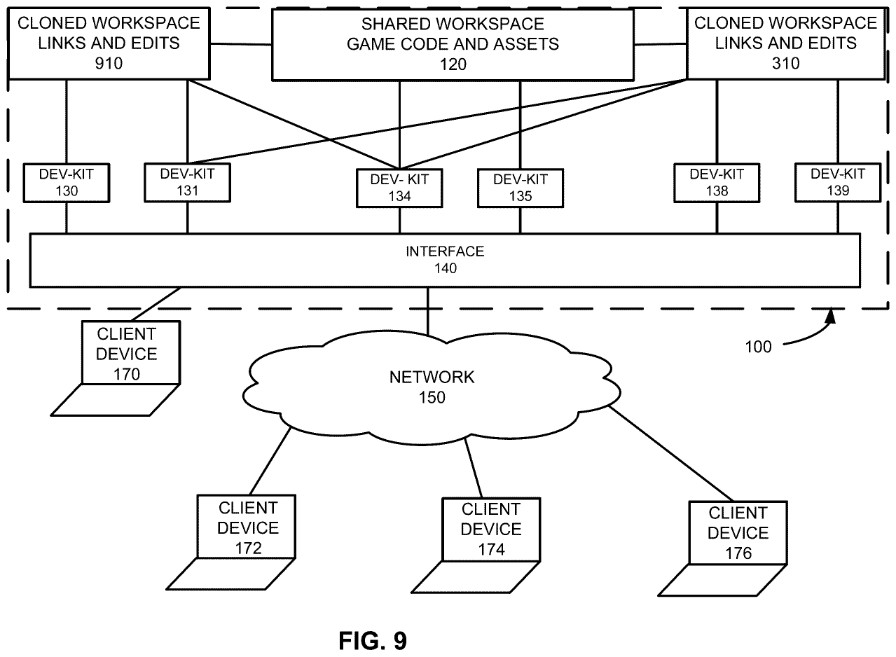

FIG. 9 illustrates another system for collaborating on the design and editing of a video game according to an embodiment of the present invention. In this example, a first group of developers can use development kit 138 and development kit 139 to edit code in first cloned workspace 310 while a second group of developers can use development kit 130 and development kit 131 to edit code in second cloned workspace 910. Still other developers can use development kit 134 and development kit 135 to edit code in shared workspace 120. As before, the various development kits can be accessed by developers via client devices 170 through interface 140 directly or via network 150.

This arrangement can provide a highly flexible and configurable collaborative system for developing game code and assets. In one example, a first developer can work on a first block of code by placing the first block of code in first cloned workspace 310 using development kit 138. First cloned workspace 310 can include links to other code that is needed from the shared workspace 120. This can quickly provide game code and assets that can be run on first virtual development kit 138 by the first developer via a client device 170.

In this example, a second developer might want to work on a second block of code in second cloned workspace 910 using development kit 131. If the second block of code is available in shared workspace 120, second cloned workspace can link to or clone the second block of code. If the second block of code is not available in shared workspace 120, the developer can use development kit 131 to access the second block of code from another cloned workspace, such as cloned workspace 310, or other source. Second cloned workspace 910 can include links to other code that is needed from shared workspace 120. This can quickly provide game code and assets that can be run on development kit 131 by the second developer.

Further in this example, a third developer might want to use development kit 134 to access the first block of code in the first cloned workspace 310 and the second block of code from the second cloned workspace 910 in a third cloned workspace (not shown) coupled to development kit 134. The third cloned workspace can link to or copy the first block of code from first cloned workspace 310 and the second block of code from second cloned workspace 910. The third cloned workspace can include links to other code that is needed from shared workspace 120. This can quickly provide game code and assets that can be run on development kit 134 by the third developer.

In this example, a conflict can arise since both development kit 131 and development kit 134 can be working on the second block of code. Accordingly, each copy of the second block of code can be assigned a version number or version identification. Other developers accessing the second block of code can then specify which version of the second block of they want to link to or clone.

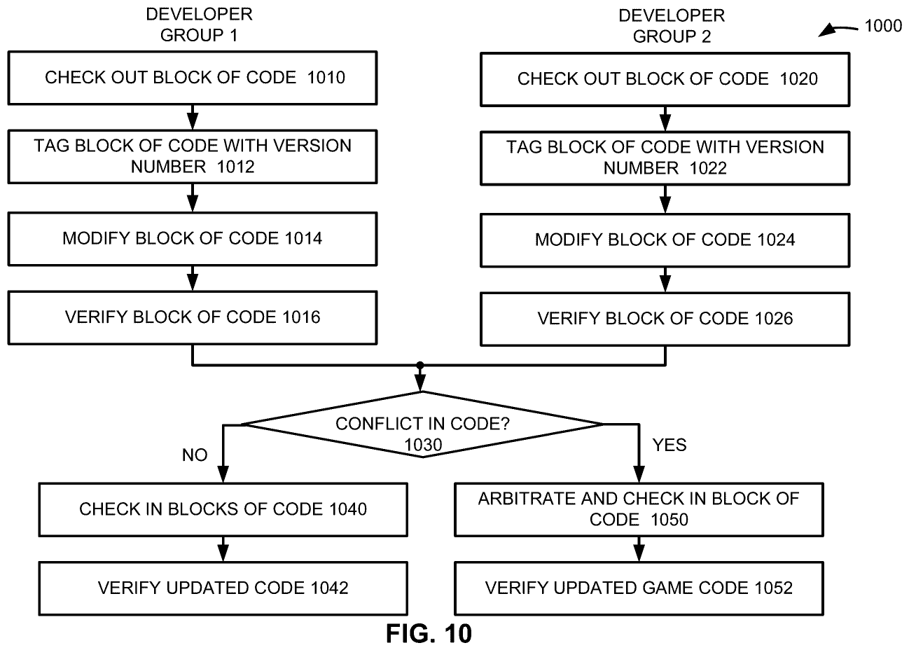

FIG. 10 illustrates another method of operating a collaboration system for the design and editing of a video game according to an embodiment of the present invention. In act 1010 of method 1000, a first developer group can check out a block of code. This can be done when a developer in the first group requests the block of code to be checked out, or a developer in the first group begins editing a block of code. This block of code can be cloned to a cloned workspace and tagged with a version number or version identification in act 1012. In act 1014, the first group of developers can modify the block of code. The edited block of code can be verified in act 1016.

Similarly, in act 1020, a second developer group can check out a block of code. This can be done when a developer in the second group requests the block of code to be checked out, or a developer in the second group begins editing a block of code. This block of code can be cloned to a cloned workspace and tagged with a version number or version identification in act 1022. In act 1024, the second group of developers can modify the block of code. The edited block of code can be verified in act 1026.

In act 1030, a determination can be made as to whether a conflict exists between the two edited blocks of code. A conflict can arise from having overlapping or interdependent lines of code, or for other reason. If there is no conflict in act 1030, then in act 1040, the blocks of code can be checked in to the shared workspace, and the code can be verified in act 1042. Any errors can be resolved by reverting to a previous version as discussed with regards to FIG. 8. If there is a conflict in act 1050, then an arbitration or other algorithm can be followed and one of the blocks of code can be checked in to the shared workspace. The updated game code in the shared workspace can be verified in act 1052.

When a conflict does arise, various algorithms can be used to determine which, of any, of the edited blocks of code can be checked in. The arbitration can be based on a first-come-first-served basis, or another algorithm can be used.

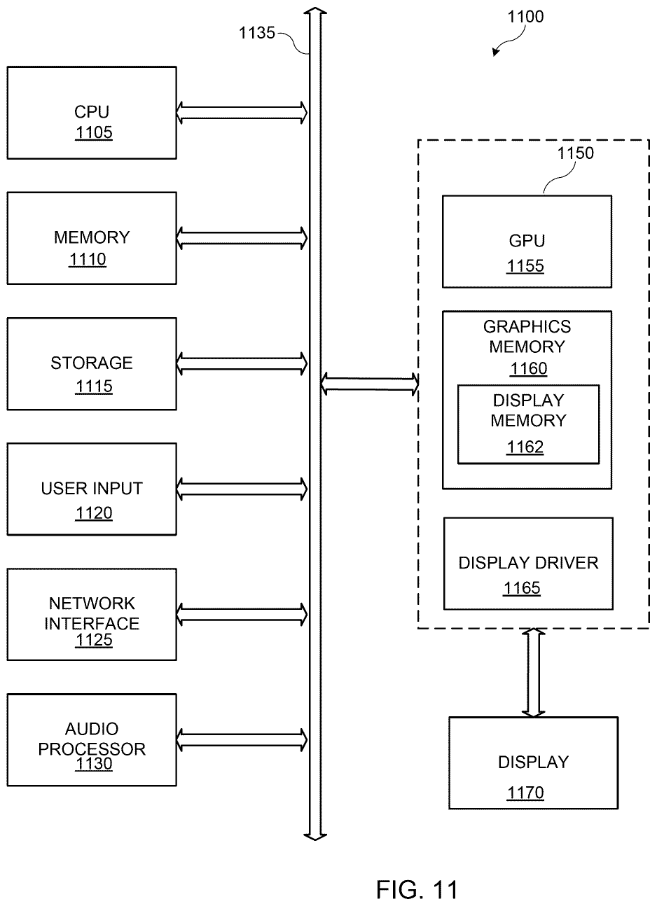

FIG. 11 illustrates a simplified block diagram of a hardware system suitable for implementing a computer system according to an embodiment of the present invention. The computer system 1100 can be, for example, a video game system, a personal computer (e.g., laptop or desktop computer), a handheld computer (e.g., a tablet or smartphone), a server computer, or other type of computer system. Computer system 1100 can include a central processing unit (CPU) 1105 capable of running software applications and optionally an operating system. CPU 1105 can include one or more homogeneous or heterogeneous processing cores implemented in one or more integrated circuits. In some embodiments, CPU 1105 can be implemented using one or more general-purpose microprocessors and/or microprocessors whose architectures are specifically adapted for highly parallel and computationally intensive applications, such as media and interactive entertainment applications. Memory 1110 can store applications and data for use by CPU 1105 and can include any combination of volatile and/or non-volatile memory components (e.g., DRAM, SRAM, etc.). Storage subsystem 1115 can provide non-volatile storage for applications and data and may include various computer readable storage media such as fixed disk drives, removable disk drives, flash memory devices, and CD, DVD, Blu-ray, HD-DVD, or other optical storage devices. User input devices 1120 can include devices that communicate user inputs from one or more users to computer system 1100. Examples of user input devices 1120 can include keyboards, mice, joysticks, touch pads, touch screens, still or video cameras, and/or microphones. In some embodiments, some or all of user input devices 1120 can be incorporated into a handheld controller that communicates with other components of computer system 1100 via a wired or wireless connection. Network interface 1125 allows computer system 1100 to communicate with other computer systems via an electronic communications network. Network interface 1125 can include hardware and associated software to support wired and/or wireless communication over local area networks and/or wide area networks such as the Internet. An audio processor 1130 can be adapted to generate analog or digital audio output signals from instructions and/or data provided by CPU 1105, memory 1110, and/or storage subsystem 1115. The components of computer system 1100, including CPU 1105, memory 1110, storage subsystem 1115, user input devices 1120, network interface 1125, and audio processor 1130 can be connected via a data bus 1135.

A graphics subsystem 1150 can also be connected to data bus 1135 and thereby to other components of computer system 1100. Graphics subsystem 1150 can include a graphics processing unit (GPU) 1155, a graphics memory 1160, and a display driver 1165. GPU 1155 can operate as a co-processor to CPU 1105 to accelerate operations associated with generating images for display. For example, GPU 1155 can support 3D rendering operations to generate pixel data for output images from instructions and data defining the geometry, lighting, shading, texturing, motion, and/or camera parameters for a scene, for instance by executing shader programs and/or other rendering programs or operations. Graphics memory 1160 can include a display memory 1162 (e.g., a frame buffer) used for storing pixel data for each pixel of an output image. Graphics memory 1160 (or portions thereof) can be integrated in the same device as GPU 1155, connected as a separate device to GPU 1155, and/or implemented within memory 1110. Pixel data can be provided to display memory 1162 directly from CPU 1105. Additionally or instead, CPU 1105 can provide GPU 1155 with data and/or instructions defining the desired output images, from which GPU 1155 can generate pixel data for one or more output images and write the pixel data to display memory 1162. Display driver 1165 can periodically output pixel data for an image from display memory 1162 to a display device 1170. Display device 1170 can be any device capable of displaying visual information in response to a signal from display driver 1165 that incorporates the pixel data; examples include CRT, LCD, plasma, LED, and OLED displays. Depending on implementation, display driver 1165 can provide display device 1170 with an analog or digital signal.

To implement data center 100 or the other data centers shown, or portions thereof, computer system 1100 can store program code implementing any or all of the modules described above. Such program code can be stored in storage subsystem 1115 and/or memory 1110 and executed using CPU 1105. A graphical user interface can be provided using a combination of display device 1170 and user input received via user input devices 1120; CPU 1105 can execute program code to display the interface and process user input.

All processes described herein are also illustrative and can be modified. Operations can be performed in a different order from that described, to the extent that logic permits; operations described above may be omitted or combined; and operations not expressly described above may be added.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code for execution by the processor. Various blocks might or might not be reconfigurable depending on how the initial configuration is obtained. Embodiments of the present invention can be realized in a variety of apparatus including electronic devices implemented using a combination of circuitry and software.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may include an internal storage medium of a compatible electronic device and/or external storage media readable by the electronic device that can execute the code. In some instances, program code can be supplied to the electronic device via Internet download or other transmission paths.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein. A network may include both wired and wireless connections, including optical links. Many other examples are possible and will be apparent to those skilled in the art in light of this disclosure.

User interfaces for a given device can be implemented using various combinations of components. For instance, a graphical user interface may present a menu of options from which the user can select by operating an input device (e.g., mouse, joystick, buttons, etc.). A speech-based interface can be responsive to specific control words or phrases that the user may speak to change settings or invoke device functions. Some user interfaces can be implemented using switches, toggles, buttons, dials, or the like that the user can set to a desired position to control a device setting or function; feedback to the user can be provided via indicator lights, haptics, sounds, or other perceptual stimuli.

All numerical values and ranges provided herein are illustrative and may be modified. Unless otherwise indicated, drawings should be understood as schematic and not to scale. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Terms such as “approximately” or “substantially” should be understood to reflect manufacturing tolerance or expectations in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

It should also be understood that audio libraries and/or video segments may contain content that is protected by copyright. It is assumed that any use of such content would be in a manner consistent with applicable copyright restrictions.

Furthermore, embodiments can be implemented by hardware, software, firmware, middleware, microcode, hardware description languages, or any combination thereof. When implemented in software, firmware, middleware, or microcode, the program code or code segments to perform the necessary tasks can be stored in a computer-readable medium such as a storage medium. Processors can perform the necessary tasks.

It should be noted that the methods, systems, and devices discussed above are intended merely to be examples. It must be stressed that various embodiments can omit, substitute, or add various procedures or components as appropriate. For instance, it should be appreciated that, in alternative embodiments, the methods can be performed in an order different from that described, and that various steps can be added, omitted, or combined. Also, features described with respect to certain embodiments can be combined in various other embodiments. Different aspects and elements of the embodiments can be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments can be practiced without these specific details. For example, well-known circuits, processes, algorithms, structures, and techniques have been shown without unnecessary detail in order to avoid obscuring the embodiments.

Also, it is noted that the embodiments can be described as a process which is depicted as a flow diagram or block diagram. Although each can describe the operations as a sequential process, many of the operations can be performed in parallel or concurrently. In addition, the order of the operations can be rearranged. A process can have additional steps not included in the figure.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A computer-implemented method of editing game code, the method comprising, with a data center:
storing source code for a video game;
providing a shared workspace;
copying the source code to the shared workspace;
providing a plurality of virtual development kits coupled to the shared workspace; and
providing an interface for a plurality of client devices to couple to the plurality of virtual development kits,
wherein when the game code is edited by a first client device using a first development kit in the plurality of development kits, the edited game code is accessible by a second client device using a second development kit in the plurality of development kits.

2. The method of claim 1 further comprising:
tagging the game code with a version number;
accepting modifications to the game code from the first client device using the first development kit;
accepting modifications to the game code from the second client device using the second development kit;
verifying the game code; and
if there is an error, then reverting to the game code with a previous version number, otherwise proceeding with the edited game code.

3. The method of claim 2 further comprising:
checking out a first block of code to the first client device by copying the first block of code to a cloned workspace.

4. The method of claim 3 wherein the first block of code is checked out to the first development kit when the first client device requests to check out the first block of code.

5. The method of claim 3 wherein the first block of code is checked out to the first development kit when the first development kit edits the first block of code.

6. The method of claim 3 wherein the first block of code is accessible and editable by the first client device using the first development kit and to a third client device using a third development kit and it not accessible or editable by a fourth client device using a fourth development kit.

7. The method of claim 3 further comprising:
checking out a second block of code to a fourth client device by copying the second block of code to a third storage location.

8. The method of claim 7 wherein the second block of code is editable and accessible by the fourth client device using a fourth development kit and a fifth client device using a fifth development kit and is not accessible or editable by the first client device using a first development kit or by a sixth client device using a sixth development kit.

9. A system comprising:
a memory; and
a processor coupled to the memory and configured to:
store source code for a video game;
provide a shared workspace;
copy the source code to the shared workspace;
provide a plurality of virtual development kits coupled to the shared workspace; and
provide an interface for a plurality of client devices to couple to the plurality of virtual development kits,
wherein when the game code is edited by a first client device using a first development kit in the plurality of development kits, the edited game code is accessible by a second client device using a second development kit in the plurality of development kits.

10. The system of claim 9 wherein the processor is further configured to tag the game code with a version number;
accept modifications to the game code from the first client device using the first development kit;
accept modifications to the game code from the second client device using the second development kit;
verify the game code; and
if there is an error, then reverting to the game code with a previous version number, otherwise proceeding with the edited game code.

11. The system of claim 10 wherein the processor is further configured to check out a first block of code to the first client device by copying the first block of code to a cloned workspace.

12. The system of claim 10 wherein the first block of code is checked out to the first development kit when the first client device requests to check out the first block of code.

13. The system of claim 10 wherein the first block of code is checked out to the first development kit when the first development kit edits the first block of code.

14. The system of claim 10 wherein the first block of code is checked out by a data center manager.

15. A computer-readable storage medium having stored therein program code instructions that, when executed by a processor in a computer system, cause the processor to perform a method comprising:
storing source code for a video game;
providing a shared workspace;
copying the source code to the shared workspace;
providing a plurality of virtual development kits coupled to the shared workspace; and
providing an interface for a plurality of client devices to couple to the plurality of virtual development kits,
wherein when the game code is edited by a first client device using a first development kit in the plurality of development kits, the edited game code is accessible by a second client device using a second development kit in the plurality of development kits.

16. The computer-readable storage medium of claim 15 wherein the method further comprises:
tagging the game code with a version number;
accepting modifications to the game code from the first client device using the first development kit;
accepting modifications to the game code from the second client device using the second development kit;
verifying the game code; and
if there is an error, then reverting to the game code with a previous version number, otherwise proceeding with the edited game code.

17. The computer-readable storage medium of claim 16 wherein the method further comprises:
checking out a first block of code to the first client device by copying the first block of code to a cloned workspace.

18. The computer-readable storage medium of claim 17 wherein the first block of code is checked out to the first development kit when the first client device requests to check out the first block of code.

19. The computer-readable storage medium of claim 17 wherein the first block of code is checked out to the first development kit when the first development kit edits the first block of code.

20. The computer-readable storage medium of claim 17 wherein the first block of code is checked out by a virtual development kit.
